(19) United States
(12) Patent Application Publication
(10) Pub. No.: US 2005/0235144 A1
(43) Pub. Date: Oct. 20, 2005

(54) Apparatus and method for computer based examinations

(76) Inventor: James P. Jacobs, Eden Prairie, MN (US)

Correspondence Address: KONDZELLA AND CYR, PONDVIEW PLAZA, SUITE 114, 5850 OPUS PARKWAY, MINNETONKA, MN, 55343, US

(21) Appl. No.: 11/105,962

(22) Filed: Apr. 14, 2005

Related U.S. Application Data
(60) Provisional application No. 60/562,216, filed on Apr. 14, 2004.

(51) Int. Cl. H04L 9/00

(52) U.S. Cl. 713/165

(57) ABSTRACT

The current invention provides apparatus and methods for distributing an electronic form which may contain an examination, displaying the electronic form to a respondent, collecting the respondent's responses to said electronic form into a response dataset, storing the response dataset locally on the respondent's computer, and transmitting the response dataset to a processing center. Distribution of the electronic form, display of the electronic form to a respondent, collection of the respondent's responses into a response dataset, storage of the response dataset, and transmission of the response dataset to a processing center may be done securely. The electronic form and response dataset may be protected by encryption and digital signature. The respondent's use of the computer may be controlled by lock-down so that the respondent can only take authorized actions and is prohibited, for example, from accessing other files on the computer or from accessing the Internet. Because only the computational resources of the respondent's computer are required in order to display the electronic form and collect the respondent's responses, the respondent's computer need not interact with any other computer or server over a network. Some embodiments of the current invention require no network connection to the respondent's computer because the electronic form is distributed to the respondent's computer and the response dataset transmitted from the respondent's computer to a processing center on external media such as CD-ROM or other optical, magnetic, or electronic media.

### BACKGROUND OF THE INVENTION

1. Field of Invention

This invention relates generally to an apparatus for the presentation of electronic forms containing examinations and recording responses to the examination and a method of use of the apparatus.

2. Description of the Related Art

Various methods and apparati for the presentation of examinations and for recording responses to the examination have been developed and refined over the last 50 years. In the basic paper-based approach, a respondent bubbles in responses on paper forms. Then the completed paper forms are converted into electronic data suitable for computer processing, for example, by optically scanning the completed paper forms.

This paper-based methodology can be inaccurate. Respondents sometimes become confused and misalign the bubble in responses with the examination items, survey items, or other data entry items. Erasures, smudges, and failure to accurately bubble in the correct area can lead to scanning errors. Errors can be a particular concern in high stakes examinations that qualify the examinee for professional licensure or admission to competitive colleges, graduate schools, and professional schools. Inaccuracies in the entry of medical or other sensitive data could also have serious consequences.

Scanning of a bubbled in paper form is being replaced with the entry of responses on a computer displayed form, herein termed an electronic form, in order to reduce error and increase processing efficiency. An electronic form is a computer-displayed form that has the ability to capture the responses of a respondent to an examination. An electronic form could display, for example, text, video, animation on a computer screen, audio output, or other computer driven display device. The respondent could respond to the electronic form by, for example, clicking on a selection box with the mouse and cursor, dialing a radio button, highlighting a selection with the mouse and cursor, and typing in a response into a response field. The respondent's responses are then collected into a response dataset. The responses are entered directly in electronic format, so the paper form and optical scanning are bypassed.

Security of examinations is essential and the shift to a completely computerized system has increased the security challenge. Information in electronic format can be widely disseminated almost instantaneously, so that strict security measures are required to preserve the confidentiality of the information. Responses to examinations must be protected from loss or alteration.

Additionally, examiners must be able to conclusively associate examination responses to a particular respondent.

Existing computerized examination systems that present an examination to a respondent are typically configured in a hub and spoke arrangement wherein a set of one or more peripheral computers or diskless workstations act as terminals. These peripheral computers or diskless workstations are networked by LAN and/or by Internet to a computer that acts as a server, as shown in FIG. 1. Respondents take the computerized examination at the peripherals, usually one respondent per peripheral.

An examination engine, which is a computer program that executes on the server, controls item presentation. Presentation of items is done in a two-step process with content and appearance determined in separate steps. FIG. 2 illustrates the flow of the presentation process in current computer based testing systems. The examination engine selects prompt/response content from a database either programmatically or from a pre-determined list and passes them to a display program that formats the prompt and responses. Generally, each prompt and response is displayed in its own fixed size window that is scrollable if the content is too large.

Reponses can be entered from the peripherals by communicating over the network with the server, which requires network communication between the server and the peripheral computer during the response entry process. The responses entered from the peripherals are stored on the server during the examination process.

An examination administrator workspace and a respondent workspace are provided on the server for administration of the computerized examination to the respondents. An examination administrator may access the examination administrator workspace either directly from the server or over the network using web browser software in order to order examinations and control the respondent's access to the examinations. The respondent accesses the examination over the network with access controlled by password. The respondent views a series of web pages containing the examination questions provided by the server. The respondent's responses are recorded in the respondent workspace on the server as the responses are entered. The server terminates the respondent's access when the time limit for the examination is reached or some other limiting condition is satisfied.

An electronic examination administration system configured in a hub and spoke arrangement requires interaction between the server and the peripheral computers or diskless workstations during an examination. The hub and spoke configuration also contemplates a controlled secure examination environment. The examination administration system does not automatically lock out the remote computers during the examination administration. Additional software must be installed on the peripheral computers to preserve the security of the examination materials. An examination administration system having a hub and spoke configuration requires a reliable network, technical personnel to secure the system and install software, sufficient machines to accommodate concurrently all respondents, and sufficient server capacity to support simultaneous interaction with all respondents that are concurrently taking the examination.

In another version of an electronic examination administration system, the respondent uses a networked peripheral computer to access a server containing an examination by web browser. The server then delivers an applet over the Internet to the examinee's peripheral computer. The applet executes on the examinee's peripheral computer. The applet administers the examination, records and analyses the respondent's answers, and terminates the examination when certain conditions are satisfied, for example, reaching the time limit, completion of the examination, or entry of enough correct or incorrect answers so that passage or failure of the examination is assured. As the examination is completed, the applet transmits the individual responses to the server so that the response dataset is stored on the server.

Another variant of an examination administration system allows for examination delivery over a secure web browser. The examination software is stored on a server, and the examinee accesses the examination by a secure web browser. A secure web browser, also known as a lock-down browser, is invoked that locks out the computer when secure content is viewed. A lock-down browser prevents unauthorized actions such as access to documents or web sites from being taken when secure content is being viewed. Use of a lock-down browser prevents the examinee from violating examination strictures by accessing unauthorized materials while viewing the form or from copying the form and disseminating the form to others. The secure web browser is not invoked when non-secure content is viewed, so that it is possible to shift between a locked-down and a non-locked-down environment during a series of interactions with this examination administration system. This system also requires interaction via web browser between the respondent at a peripheral computer and a server.

The systems described above require interaction with a server over a network while the respondent is interacting with the electronic form and the responses are being collected and stored on the server. When large numbers of electronic forms are being displayed simultaneously, for example, when a large number of examinations are being given simultaneously, sufficient server capacity and network capacity must be provided to support interaction over the network with a large number of respondents. A network-based examination administration system suffers from variability in capacity and quality of network service. This variability in network quality and capacity can affect the reliability of the examination and impact the experience of the respondents. Similarly, inadequate server capacity can also adversely affect the examination. Network problems and server problems could also adversely affect the use of electronic forms in other contexts such as surveys and data entry.

The present invention can achieve the efficiencies of electronic processing, maintain security, and link the responses to a particular respondent while minimizing network traffic and minimizing server capacity.

### SUMMARY OF THE INVENTION

The current invention provides apparatus and methods for distributing an electronic form, displaying the electronic form to a respondent, collecting the respondent's responses to said electronic form into a response dataset, storing the response dataset locally on the respondent's computer, and transmitting the response dataset to a processing center. Distribution of the electronic form, display of the electronic form to a respondent, collection of the respondent's responses into a response dataset, storage of the response dataset, and transmission of the response dataset to a processing center may be done securely.

The respondent's use of the computer may be controlled by lock-down so that the respondent can only take authorized actions and is prohibited, for example, from accessing other files on the computer or from accessing the Internet.

Because only the computational resources of the respondent's computer are required in order to display the electronic form and collect the respondent's responses, the respondent's computer need not interact with any other computer or server over a network. Some embodiments of the current invention require no network connection to the respondent's computer because the electronic form is distributed to the respondent's computer and the response dataset transmitted from the respondent's computer to a processing center on external media such as CD-ROM or other optical, magnetic, or electronic media.

The apparatus and methods of the current invention will also provide additional improvements and advantages that will be recognized by those skilled in the art upon review of the following detailed description of a preferred embodiment of the invention when taken in conjunction with the drawings, wherein like reference numerals refer to corresponding parts in the several views.

### BRIEF DESCRIPTION OF THE DRAWINGS

FIG. 1 illustrates set of peripheral computers or diskless workstations connected in a hub and spoke configuration to a server by local area network (LAN) and/or by Internet;

FIG. 2 illustrates the flow of the presentation process in current computer based testing systems;

FIG. 3 illustrates an embodiment of the apparatus having an activation component, a display component, a response collection component, and a transmission component that transmits the response dataset to a processing center;

FIG. 4 illustrates an embodiment of the activation component of the apparatus;

FIG. 5 illustrates a typical display of examination questions on a computer screen by an electronic form;

FIG. 6 illustrates an embodiment of the display component of the apparatus;

FIG. 7 illustrates an embodiment of the collection component of the apparatus;

FIG. 8 illustrates an embodiment of a response dataset;

FIG. 9 illustrates an embodiment of the transmission component;

FIG. 10 illustrates the interactions of the respondent with an embodiment of the apparatus; and,

FIG. 11 illustrates a manner of using an embodiment of the apparatus.

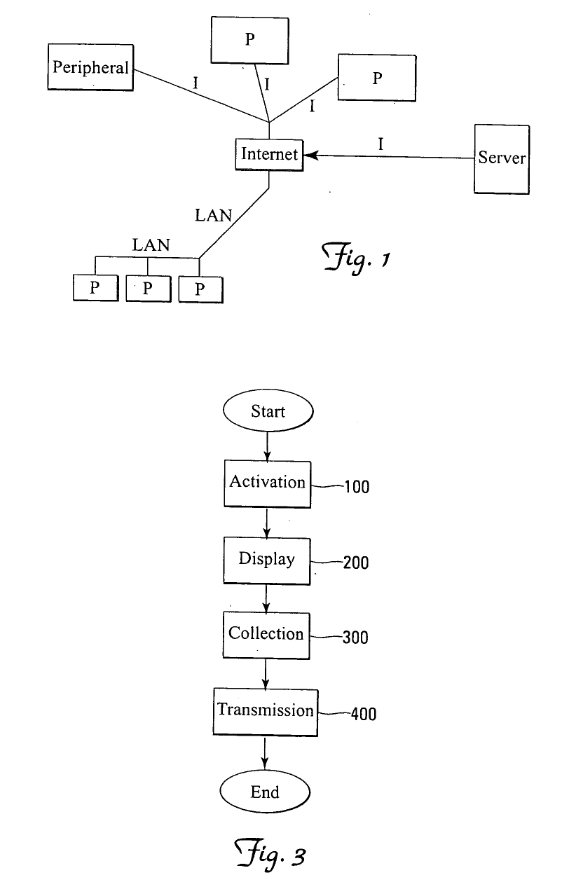

### DETAILED DESCRIPTION OF THE INVENTION

The following detailed description of the present invention refers to subject matter in the accompanying drawings which show, by way of illustration, specific aspects and embodiments in which the present invention may be practiced. These embodiments are described in sufficient detail to enable those skilled in the art to practice the present invention. It will be apparent to one skilled in the art that the various embodiments may be practiced without inclusion of some of the specific aspects. References to “an”, “one”, or “various” embodiments in this disclosure are not necessarily to the same embodiment, and such references contemplate more that one embodiment. The following detailed description is, therefore, not to be taken in a limiting sense, and the scope is defined only by the appended claims, along with the full scope of legal equivalents to which such claims are entitled.

The apparatus is in the form of a computer program that displays an electronic form, wherein said electronic form may be an examination that elicits a response from a respondent. Said apparatus collects the respondent's responses to the electronic form into a response dataset, stores the response dataset on the respondent's computer, and transmits the response dataset to a processing center for processing.

In order to display the electronic form and collect the responses to the electronic form into a response dataset, the apparatus uses only the computational resources of the respondent's computer. The apparatus does not require network access in order to display the electronic form, collect the respondent's responses into a response dataset, and store the response dataset. Because the apparatus may be transmitted to the respondent's computer on external media, and because the response dataset may be transmitted from the respondent's computer to a processing center on external media, the apparatus may not require the respondent's computer to be connected to a network.

FIG. 3 shows an embodiment of the apparatus, said embodiment having an activation component 100, a display component 200, a respondent's response collection component 300, and a component that transmits the respondent's response dataset to a processing center 400.

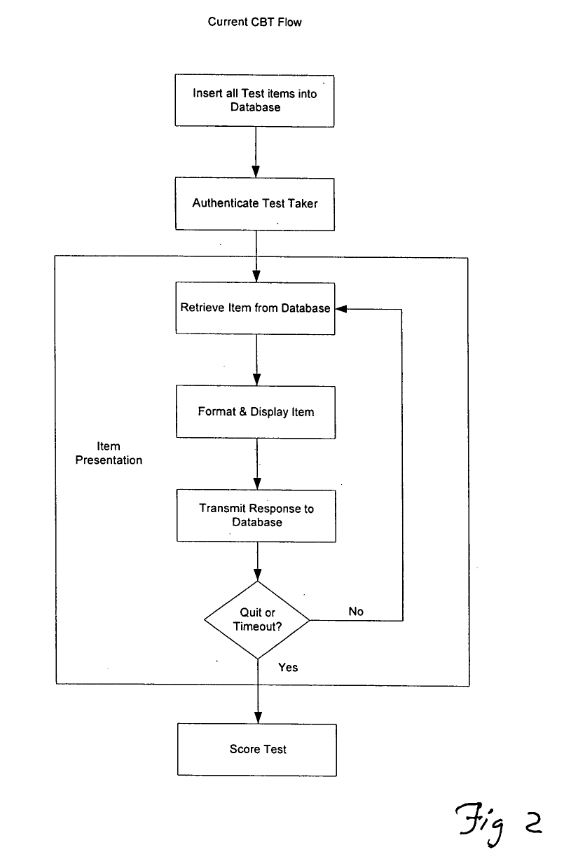

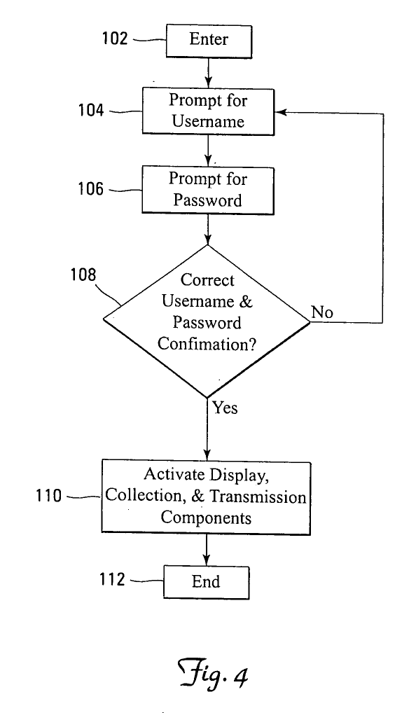

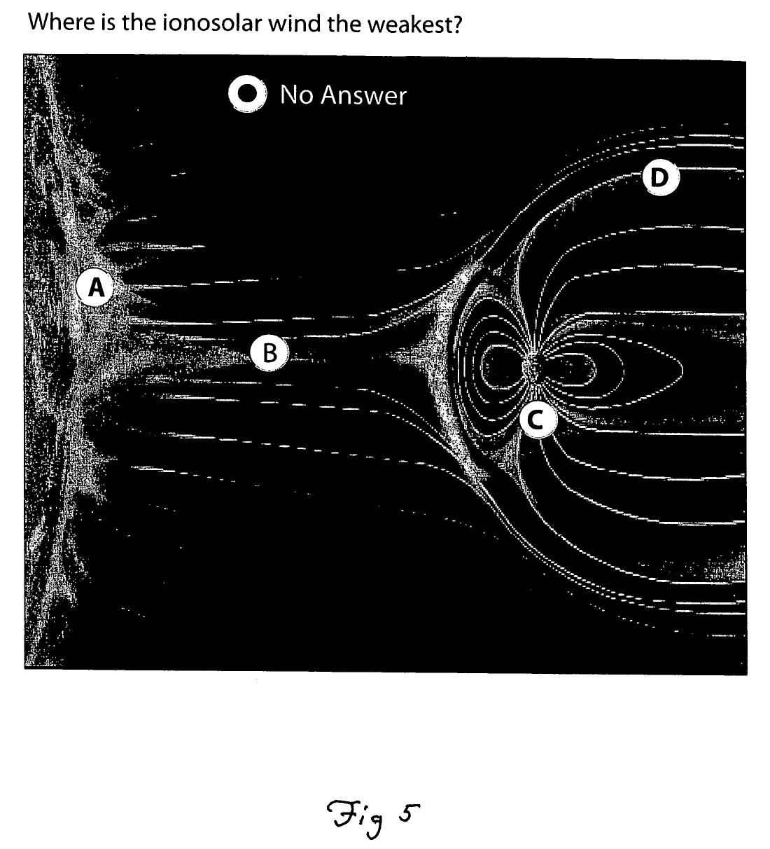

The activation component 100 allows the respondent to activate the apparatus. The activation component may have security features such as password protection or encryption. FIG. 4 illustrates an embodiment of the activation component. The activation component is entered at 102. The activation component prompts the respondent to login by entering a username 104 and password 106. If the respondent enters the correct username and password combination 108, the display 200, collection 300, and transmission 400 components are activated 110, otherwise the respondent is prompted for username and password. A counter may be added to limit the number of login attempts.

Encryption may be incorporated into some embodiments of the activation component. The respondent would obtain decryption information by contacting a Public Key Infrastructure (PKI) or in other ways recognizable to those skilled in the art. When the appropriate decryption information is relayed to the activation component, the activation component would decrypt and activate the display 200, collection 300, and transmission 400 components.

In one embodiment of the present invention, a respondent provides a login username and password, and the activation component contacts a PKI to obtain a key for decryption of the electronic form. It should be understood that these embodiments of the activation component are not exhaustive, but are presented to illustrate the scope of the present invention. Other embodiments and modifications are possible, as would be recognized by one skilled in the art based upon the present disclosure.

The display component 200 of the apparatus displays the electronic form that may be an examination that elicits a response from a respondent. The display component 200 may interact with the respondent, and captures the respondent's responses to the electronic form. The electronic form may be displayed in the form of graphical images, which may be stationary images, moving images, or a combination of moving and stationary images, may include text, and may include audio as would be recognized by one skilled in the art. The electronic form may include fields for response collection that are defined in parts of the electronic form. The fields for response collection may use various techniques of recording selections recognizable to those skilled in the art. Various embodiments of the apparatus present an electronic form that uses item prompts and stems comprised of text and graphics to record responses. In various embodiments, a stem selection includes selection of a response from several responses. Other fields for response collection may be used, as would be recognized by one skilled in the art based upon the present disclosure.

FIG. 6 illustrates an embodiment of the display component 200. Item presentation is a one step process. The electronic form is rendered on the display 268. The responses are entered into the response dataset 270 and a quit or timeout condition is checked for 272. Content and appearance is part of the electronic form and is determined when the electronic form is constructed. There is no examination engine needed and the display program renders the appearance according to the definition in the electronic form. Any unique functionality is implemented in scripts contained in the electronic form and executed by the generic rendering program. Every examination can have a different layout and functionality. The whole examination document is in a scrollable window so item appearance is unbroken. The examinee has control over the appearance, for example, by being able to resize windows, hide/show tools, and zoom in or out. A lock-down feature may be included.

Additional embodiments may use multimedia techniques such as audio, video, or animation to interact with a respondent and record the respondent's responses. As an example, an embodiment of the present invention may accommodate hearing-impaired respondents by displaying video that includes, in part, hand signals adapted for communication with the hearing-impaired.

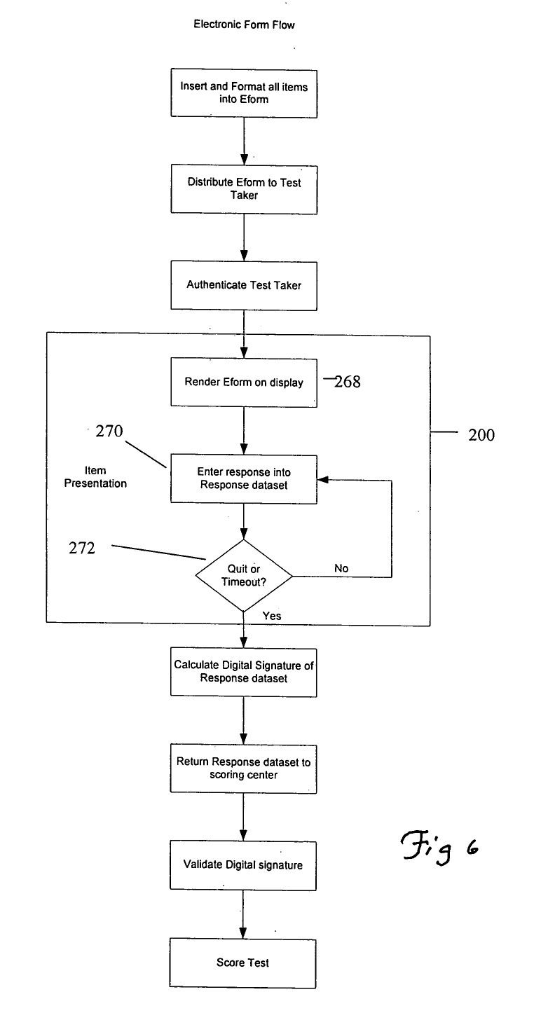

Various embodiments of the current invention may also include items arranged in pages on an electronic form. One example of the current invention provides a page that contains one or more items, and further examples include several items that can be presented on several pages. A typical display of an electronic form is shown in FIG. 5, which shows an examination question presented on a page. The respondent selects an answer by clicking on an active button adjacent to each presented choice. The respondent can also scroll forward and backward to other examination items or quit the examination.

Various other embodiments of the display component 200 may include techniques for navigating multiple pages, marking items for review, highlighting stems, making notes, and context may be provided with an item that directs the respondent to reference information that spans multiple pages as would readily be recognized by those skilled in the art. One embodiment includes an electronic form compatible with the portable document format (“PDF”) standard. In various embodiments, the ability of the respondent to enter responses into the electronic form may be limited to a specified time period and or a specified location. Varying embodiments of the present invention include programmatically interacting with a respondent in response to respondent stem selections and actions. In various examples, the acceptable actions in a given field may be restricted, and in some examples, the method can provide feedback about a respondent's action at a predetermined time after the respondent's action occurs as would be recognized by one skilled in the art. One example provides feedback in response to a set of actions at a predetermined time after the actions have been recorded.

It should be understood that these forms of navigation, display, and interaction with the respondent are not exhaustive, but are presented to illustrate the scope of the present invention. Other modifications are possible, as would be recognized by one skilled in the art based upon the present disclosure.

The collection component 300 of the apparatus collects the responses that the respondent has entered into the fields for response defined in parts of the electronic form. The fields for response collection may use various techniques of recording the respondent's responses recognizable to those skilled in the art such as using radio buttons, checkboxes, text boxes, combo boxes, location of mouse clicks on a graphic, and series of actions indicating the response to a prompt.

An embodiment of the collection component 300 of the apparatus is shown in FIG. 7 wherein the collection component 300 writes the respondent's response 304 to a response dataset. The response dataset file may be structured as shown in FIG. 8. The response dataset is stored locally on the respondent's computer. The response dataset may be stored on external media.

As would be recognized by one skilled in the art, response datasets may contain a variety of respondent's responses such as keyed in responses, handwritten markings, a selection among a group of options presented on a screen, audio samplings, visual samplings, the timing and or the sequence of responses, a performance response to a prompt, or data entered by the respondent.

Some examples of the present invention include separating the respondent's responses from the form. It should be understood that these forms of recording the respondent's responses are not exhaustive, but are presented to illustrate the scope of the present invention. Other response datasets and response dataset configurations would also be recognized by those skilled in the art.

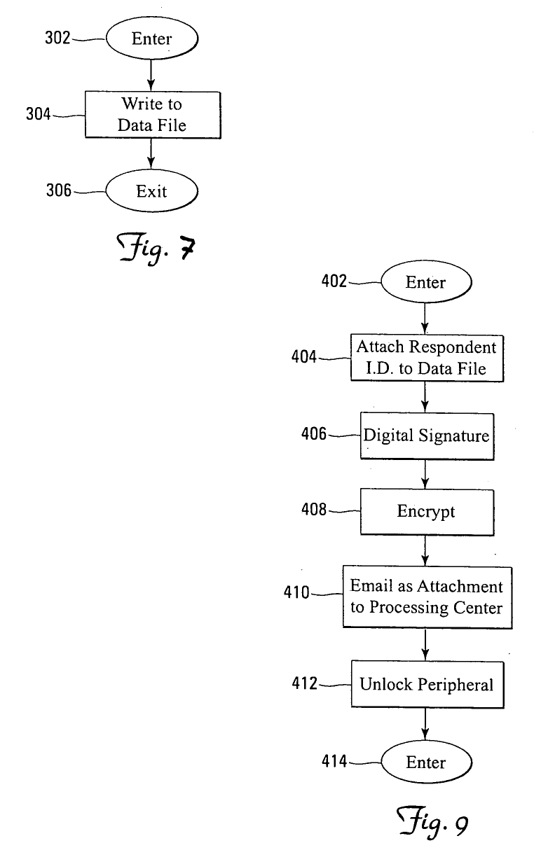

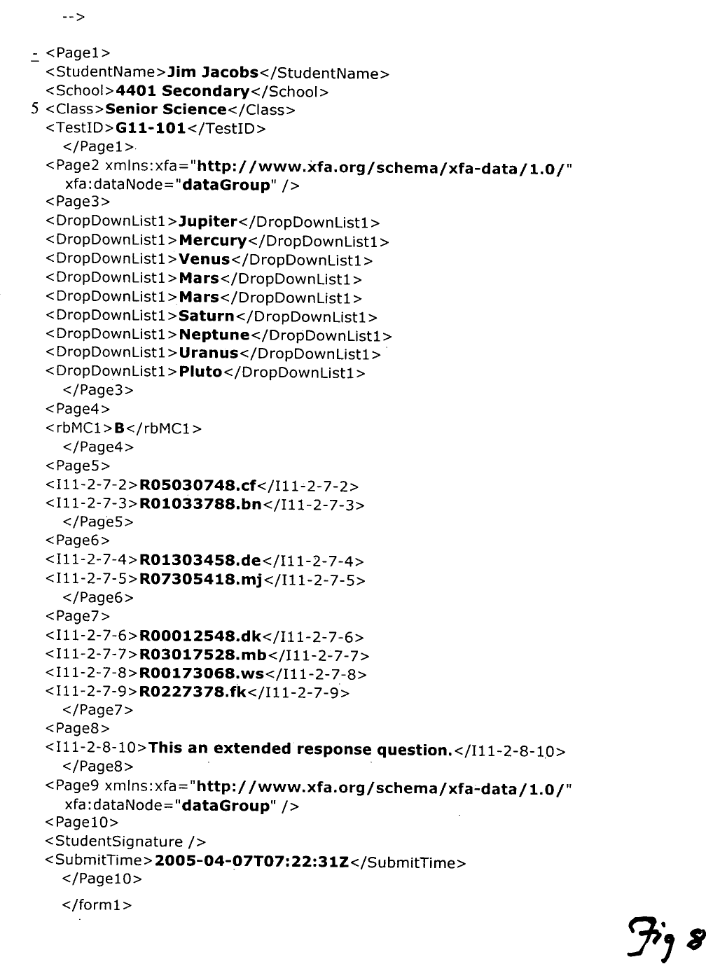

The transmission component 400 of the apparatus transmits the response dataset, which contains the collected respondent's responses, to a processing center. FIG. 9 illustrates an embodiment of the transmission component. A digital signature is attached 406 to the response dataset. The response file with the attached digital signature is encrypted 408. The encrypted response dataset with attached digital signature is then sent to a processing center by email as an attachment 410. Then, the respondent's computer is unlocked 412.

In some embodiments, a finished examination, survey or other electronic form is encrypted, for example, based on a key obtained from a PKI. Additionally, some embodiments use a time stamp to further identify and restrict access to the completed electronic form.

As would be recognized by one skilled in the art, the response dataset could be transmitted by other modalities such as FTP. The encrypted response file with attached digital signature could be written to external media. Said external media may then be mailed to a processing center by postal service or other currier.

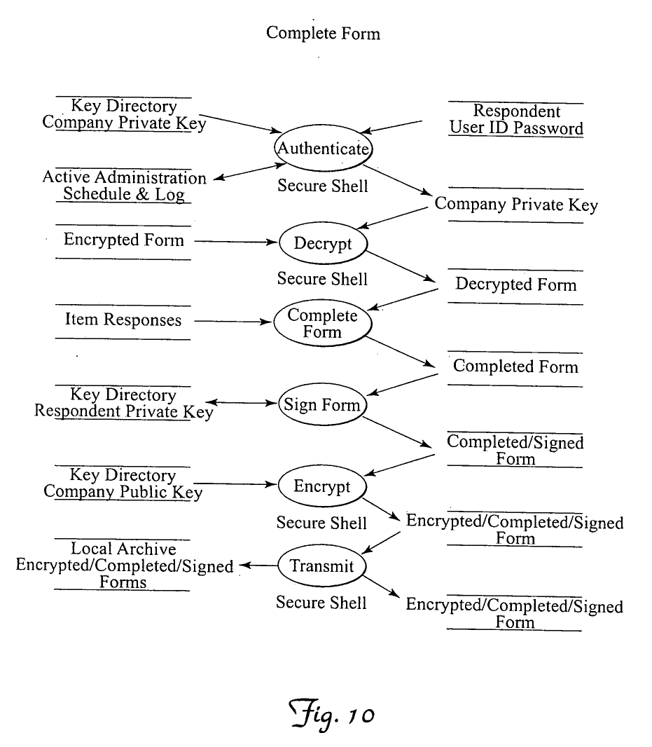

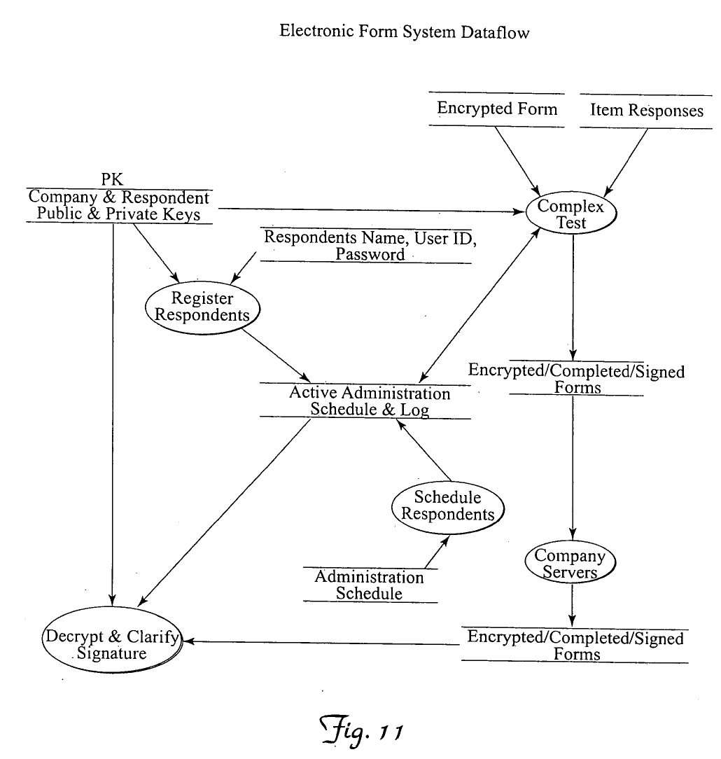

FIG. 10 illustrates the interactions of the respondent with an embodiment of the apparatus. The respondent is authenticated and the electronic form may be decrypted using a security key. Upon completion, the electronic form including the response dataset may be combined with an individualized electronic signature, encrypted, and transmitted to a processing center.

It should be understood that these forms of collecting, managing, and transmitting the response dataset are not exhaustive, but are presented to illustrate the scope of the present invention. Those skilled in the art would recognize other techniques for collecting, managing, and transmitting the response dataset. It should be understood that these embodiments of transmitting the response dataset are merely illustrative and are not offered in a limiting sense.

The apparatus may be used in the following fashions. In one exemplary embodiment of usage, a respondent situated at a computer receives the apparatus as an executable file attached to an email. The respondent then initiates the apparatus by placing a cursor on the apparatus and clicking a mouse. The apparatus then executes. As per the exemplary embodiments contained in this disclosure, the apparatus prompts the respondent for login information, a username and password. When the respondent enters the correct username and password, the apparatus locks down the peripheral and displays the electronic form that may be an examination, survey, or other electronic form that elicits a response from the respondent. The respondent enters responses to prompts within the electronic form. The respondent's responses are collected into a response dataset, which is stored locally on the respondent's computer. When the apparatus detects a quit or timeout 272, the apparatus attaches the respondent's digital signature to the response dataset, encrypts the response file with attached digital signature, and transmits the encrypted response dataset with attached digital signature to a processing center. The apparatus then unlocks the respondent's computer.

Additional embodiments of usage include the generation of at least one security key for the respondent. In one example, a pair of security keys is generated. One key of the paired security keys is available for public use, and one key of the paired security keys is kept private. In various embodiments, a respondent is provided with a login username and a password. Varying embodiments tie the one or more security keys to the login username and the password of the respondent. In one example, security keys are stored at a PKI for later retrieval by the respondent upon entry of the login username and password.

Additional embodiments of usage include the distribution of the apparatus on external media. Further embodiments of the present invention include the distribution of the apparatus via FTP or other techniques readily apparent to one skilled in the art upon review of the present disclosure. The apparatus distribution technique may differ from the response dataset transmission techniques. For example, the apparatus may be sent by email and the response dataset stored on external media, and the external media sent to a processing center by postal service.

Additional apparatus distribution techniques are encompassed by the scope of the present invention that would be apparent to one skilled in the art upon review of the present disclosure. Additional response dataset transmission techniques are encompassed by the scope of the present invention that would be apparent to one skilled in the art upon review of the present disclosure.

FIG. 11 illustrates a manner of using an embodiment of the apparatus. This includes registering a respondent, securely providing an electronic form, administering the electronic form in a secure environment, collecting the completed electronic form including responses, preparing the electronic form for secure electronic transmission to a processing center, and transmitting the completed electronic form to a processing center.

Although specific embodiments have been illustrated and described herein, it will be appreciated by those of ordinary skill in the art that any arrangement that is calculated to achieve the same purpose may be substituted for the specific embodiment shown. It is to be understood that the above description is intended to be illustrative and not restrictive. Combinations of the above embodiments and other embodiments will be apparent to those having skill in the art upon review of the present disclosure. The scope of the present invention should be determined with reference to the appended claims, along with the full scope of equivalents to which such claims are entitled.

1. An apparatus in the form of a computer program for collecting a respondent's responses to an electronic form comprising:
An activation component that initiates the apparatus;
a display component that displays an electronic form to a respondent;
a collection component that stores a response dataset on the respondent's computer; and, a transmission component that transmits the response dataset to a processing center.

2. An apparatus in the form of a computer program for collecting a respondent's responses to an electronic form comprising:
An activation component that initiates the apparatus;
a display component that displays an electronic form to a respondent and locks out respondent's computer;
a collection component that securely stores a response dataset on the respondent's computer; and, a transmission component that securely transmits the response dataset to a processing center.

3. The apparatus of claim 1, wherein an encrypted electronic form is decrypted.

4. The apparatus of claim 1, wherein a password is required to display the electronic form.

5. The apparatus of claim 1, wherein said response dataset includes a digital signature.

6. The apparatus of claim 1, wherein the response dataset is encrypted.

7. A method for obtaining a respondent's responses to an electronic form comprising: distributing an electronic form to a respondent's computer;
displaying the electronic form to the respondent; collecting the respondent's responses to the electronic form into a response dataset where the response dataset is stored on the respondent's computer; and,
transmitting the response dataset to a processing center.

8. The method of claim 7, wherein the electronic form is distributed to respondent's computer as an email attachment.

9. The method of claim 7, wherein the electronic form is distributed to respondent's computer on external media.

10. The method of claim 7, further comprising limiting access to the electronic form to a registered respondent.

11. The method of claim 9, further comprising distributing an encrypted electronic form to the respondent's computer.

12. The method of claim 7, further comprising attaching a digital signature to said response dataset.

13. The method of claim 12, further comprising encrypting said response dataset.

14. The method of claim 7, wherein the response dataset is transmitted to the processing center as an email attachment.

15. The method of claim 7, wherein the response dataset is transmitted to the processing center on external media.

16. A method for obtaining a respondent's responses to an electronic form comprising:
limiting access to the electronic form to a registered respondent;
distributing an electronic form to the registered respondent's computer;
locking down the registered respondent's computer;
displaying the electronic form to the registered respondent;
collecting the registered respondent's responses to the electronic form into a response dataset where the response dataset is stored on the registered respondent's computer;
attaching a digital signature to the response dataset; and,
transmitting the response dataset to a processing center.

17. A method for obtaining a respondent's responses to an electronic form comprising:
limiting access to the electronic form to a registered respondent;
distributing an electronic form to the registered respondent's computer;
locking down the registered respondent's computer;
displaying the electronic form to the registered respondent;
collecting the registered respondent's responses to the electronic form into a response dataset where the response dataset is stored on the registered respondent's computer;
attaching a digital signature to the response dataset;
encrypting the response dataset; and,
transmitting the response dataset to a processing center.
